(19) United States
(12) Patent Application Publication
(10) Pub. No.: US 2022/0241748 A1
(43) Pub. Date: Aug. 4, 2022

(54) REACTION MIXER

(71) Applicant: Philadelphia Mixing Solutions, Ltd., Palmyra, PA (US)

(72) Inventors: Todd Michael Hutchinson, Palmyra, PA (US); Richard Kenneth Grenville, Palmyra, PA (US); Jason Jon Giacomelli, Paimyra, PA (US); Benjamin Aaron Boyer, Palmyra, PA (US)

(21) Appl. No.: 17/608,561

(22) PCT Filed: Jun. 5, 2019
(86) PCT No.: PCT/US2019/035543

§ 371 Date: Nov. 3, 2021

Related U.S. Application Data
(60) Provisional application No. 62/842,824, filed on May 3, 2019.

(51) Int. Cl. B01J 19/20; B01F 27/191; B01F 27/91; B01F 35/53; B01J 19/02; B01J 19/00; B01J 8/22

(52) U.S. Cl. CPC B01J 19/20; B01F 27/191; B01F 27/91; B01F 35/53; B01F 2215/0431; B01J 19/0066; B01J 8/222; B01F 2215/0427; B01J 19/02

(57) ABSTRACT

An agitator or mixer installed in a solid-liquid-gas/slurry reactor in which gas removal from the slurry and foam destruction is promoted. The reaction mixer includes a vessel and an agitator assembly. The vessel is for containing the solid-liquid-gas mixture and defines two mixing zones within a given volume; a first mixing zone and a second mixing zone located above the first mixing zone. The agitator assembly is positionable within the vessel and comprises a rotatable shaft and a first and second impeller coupled to the shaft. The first axial impeller is locatable within the first mixing zone and is configured to pump the liquid in a downward direction along a vertical axis of rotation. The second impeller is locatable within the second fluxing zone and is configured to pump the liquid in an upward direction along the vertical axis of rotation.

### TECHNICAL FIELD

This disclosure relates generally to a reaction mixer and, more particularly, to a system and method for removal of foam or entrained gas.

### BACKGROUND

The production of phosphoric acid involves a series of reaction tanks where phosphate rock (Ca3PO4-calcium phosphate ore) is reacted with sulfuric acid. The reaction produces calcium sulfate, phosphoric acid, carbon dioxide, and trace (inert) minerals. Phosphoric acid reactors provide contact between the phosphate rock particles and the acid and, because the carbon dioxide interferes with the reaction between the rock and the acid, the reactors promote de-gassing by promoting gas transport to the surface where the gas coalesces into a foam layer and is removed.

During the reaction, calcium sulfate (gypsum) crystals form, especially in dead zones in the reactor. The agglomerated build-up reduces process yields by adhering to walls of the reactor reducing volume and retention time and to surfaces of impeller blades reducing the pumping performance of the impellers. In addition, accumulations can become large enough to break off and destroy impeller blades, shafts, mixer drives, or other components of the agitator assemblies. The buildup eventually reduces tank capacity and can cause dangerous working conditions during maintenance of the tank.

The costs to replace components of the agitator assembly are high. Frequently, the build-up on the walls of the reaction tanks break off coming in contact with the rotating agitator assembly resulting in shock load damage to the gear box driving the agitator assembly, resulting in frequent mixer drive, agitator shaft and impeller repairs.

Reaction tanks are often shut-down for several days for the time-consuming process of cleaning out accumulation as the tank walls become increasingly coated with the large particles. Thus, accumulation in phosphoric acid systems reduces efficiency and overall output, increases maintenance and replacement parts, and often causes tanks to be oversized in anticipation of build-up during operation.

### SUMMARY

Many conventional phosphoric acid reactors include impellers that are configured to down-pump the liquid contained within the tank with a radial pumping foam breaker located at the surface as it has been believed that forming a single mixing zone is required for suspending the calcium sulfate solids contained within the liquid. Contrary to this conventional wisdom, the inventors have developed a reaction mixer with multiple flow patterns that are produced by at least two impellers pumping the liquid within the tank in opposite directions.

An aspect of the present disclosure provides a reactor for removal of entrained gas from a solid-liquid mixture. The reactor comprises a vessel and an agitator assembly. The vessel is configured to contain the solid-liquid mixture within and defines a first mixing zone and a second mixing zone located above the first mixing zone. The agitator assembly is positionable within the vessel and comprises a rotatable shaft, a first impeller, and a second impeller. The rotatable shaft is configured to rotate about a vertical axis of rotation. The first impeller is coupled to the rotatable shaft at a first axial location. The first axial location is locatable within the first mixing zone. The first impeller is configured to pump the liquid in a downward direction along the vertical axis of rotation. The second impeller is coupled to the rotatable shaft at a second axial location, the second axial location is locatable within the second mixing zone. The second impeller is configured to pump the liquid in an upward direction along the vertical axis of rotation.

Another aspect of the present disclosure provides a phosacid reactor. The phosacid reactor comprises at least one vessel, a slurry (solid-liquid) mixture, and the agitator assembly positioned within the at least one vessel such that the first impeller is positioned within the first mixing zone and the second impeller is positioned within the second mixing zone. The at least one vessel comprises between one and fifteen vessels that each includes an agitator assembly positioned within (e.g. The reactor train comprises from 1 to 15 cells). The liquid mixture comprises a phosphate rock and sulfuric acid.

Another aspect of the present disclosure includes a method for removing entrained gas within a liquid. The method comprises: filling a vessel with a liquid, the vessel defining a first mixing zone and a second mixing zone, the liquid filling the first and second mixing zones; positioning the agitator assembly within the vessel, the positioning step comprising: positioning the first impeller within the first mixing zone, and positioning the second impeller within the second mixing zone; and rotating the rotatable shaft about the vertical axis of rotation causing the first impeller to pump the liquid in the downward direction and causing the second impeller to pump the liquid in the upward direction.

Another aspect of the present disclosure provides an agitator assembly for use in a vessel of a reactor to remove entrained gas and suspend undissolved solids. The vessel is configured to contain a liquid within a first mixing zone and a second mixing zone located above the first mixing zone. The agitator assembly comprises a rotatable shaft, a first impeller, and a second impeller. The rotatable shaft is configured to rotate about a vertical axis of rotation. The first impeller is coupled to the rotatable shaft at a first axial location that is locatable within the first mixing zone. The first impeller is configured to pump the liquid in a downward direction along the vertical axis of rotation. The second impeller is coupled to the rotatable shaft at a second axial location that is locatable within the second mixing zone. The second impeller is configured to pump the liquid in an upward direction along the vertical axis of rotation. The agitator assembly is configured to produce (a) an inner downward flow and an outer upward flow in the first mixing zone and (b) an inner upward flow and an outer downward flow in the second mixing zone when the rotatable shaft is rotated and the first impeller is positioned within the first mixing zone and the second impeller is positioned within the second mixing zone.

Another aspect of the present disclosure provides a method of manufacturing a reactor cell for removing entrained gas from a liquid. The reactor cell includes a vessel configured to contain the liquid within a first mixing zone and a second mixing zone located above the first mixing zone. The method comprises: coupling a first impeller to a rotatable shaft at a first axial location, the first axial location being locatable within the first mixing zone, the first impeller being configured to pump the liquid in a downward direction; and coupling a second impeller to the rotatable shaft at a second axial location, the second axial location being locatable within the second mixing zone, the second impeller being configured to pump the liquid in an upward direction. The rotatable shaft is configured to rotate about a vertical axis of rotation, and the first impeller and the second impeller are configured to produce (a) an inner downward flow and an outer upward flow in the first mixing zone and (b) an inner upward flow and an outer downward flow in the second mixing zone when the rotatable shaft is rotated and the first impeller is positioned within the first mixing zone and the second impeller is positioned within the second mixing zone.

This summary is provided to introduce a selection of concepts in a simplified form that are further described below in the Detailed Description section. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there are shown in the drawings illustrative embodiments of the disclosure. It should be understood, however, that the application is not limited to the precise arrangements and instrumentalities shown. In the drawings:

FIG. 1 illustrates a perspective view of a reactor cell and agitator assembly, according to an aspect of this disclosure.

FIG. 2 illustrates a top view of the reactor cell and the agitator assembly illustrated in FIG. 1.

FIG. 3 illustrates a side cross sectional view of the reactor cell illustrated in FIG. 1 taken along line 3-3 in FIG. 2.

FIG. 4 illustrates a side view of an inside of a reactor cell, according to an aspect of this disclosure.

FIG. 5 illustrates a side view of the inside of the reactor cell illustrated in FIG. 4 with liquid flow patterns.

### DETAILED DESCRIPTION

An agitator assembly for use in a reactor cell to remove surface foam and entrained gasses within a liquid is disclosed. The agitator assembly includes a rotatable shaft with a first impeller and a second impeller coupled thereto. The first impeller is a down-pumping impeller located toward the bottom of the shaft, and the second impeller is an up-pumping impeller positioned above the first impeller. The size of each impeller and the location of each impeller along the shaft may depend on the dimensions of the reactor cell and the level of the liquid contained within, as discussed in further detail below. The agitator assembly is positioned within the reactor cell such that the first impeller is positioned with a first mixing zone and the second impeller is positioned within a second mixing zone. As the shaft rotates, the first impeller produces an inner downward flow and an outer upward flow in the first mixing zone and the second impeller produces an inner upward flow and an outer downward flow in the second mixing zone, producing two flow patterns in a reactor cell (e.g. the first mixing zone and the second mixing zone).

Certain terminology used in this description is for convenience only and is not limiting. The words “upward”, “downward”, “axial”, “transverse,” and “radial” designate directions in the drawings to which reference is made. The term “substantially” is intended to mean considerable in extent or largely but not necessarily wholly that which is specified. All ranges disclosed herein are inclusive of the recited endpoint and independently combinable (for example, the range of “from 2 grams to 10 grams” is inclusive of the endpoints, 2 grams and 10 grams, and all the intermediate values). The terminology includes the above-listed words, derivatives thereof and words of similar import.

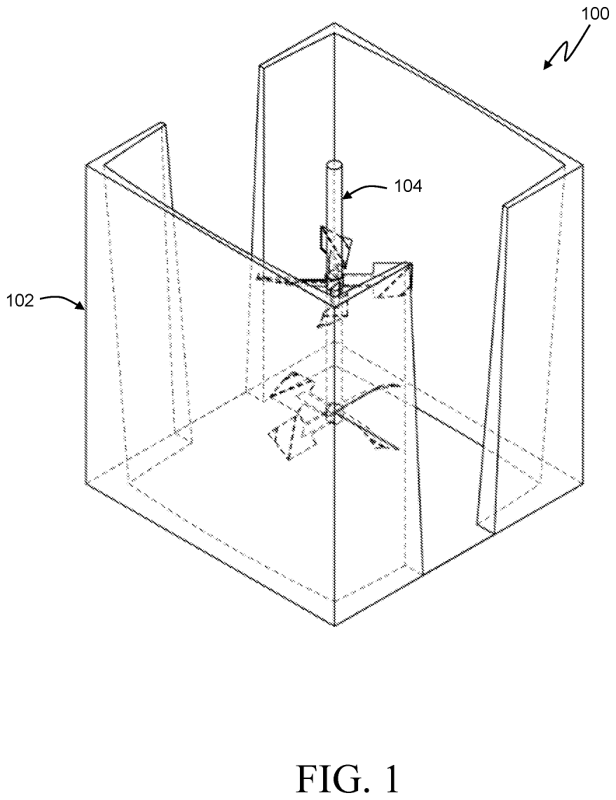

FIG. 1 illustrates a perspective view of a reactor cell 100, according to an aspect of this disclosure. The reactor cell 100 includes a vessel 102 and an agitator assembly 104. The reactor cell 100 may be one of several reactor cells that compose a reactor. For example, a reactor may include eight reactor cells arranged in series such that each cell includes a vessel and an agitator assembly that empties into a downstream cell. It will be appreciated that a reactor may include fewer or more reactor cells. Each reactor cell 100 is capable of removing surface foam and entrained gasses within a liquid mixture being processed through the reactor.

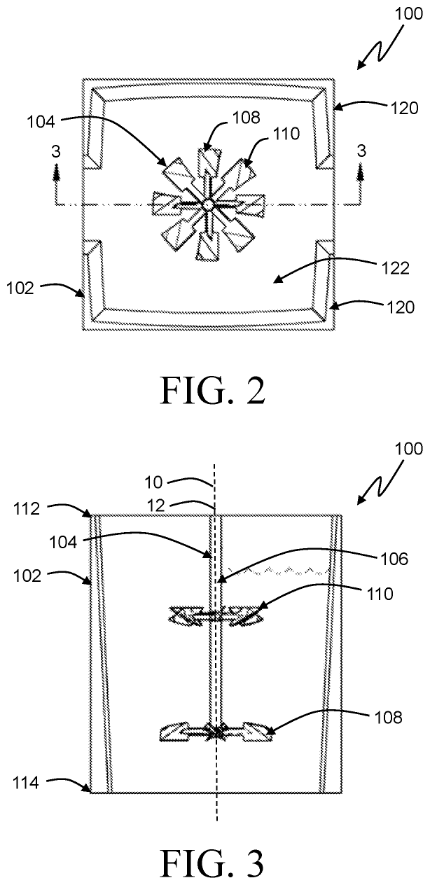

FIG. 2 illustrates a top view of the reactor cell 100 illustrated in FIG. 1, and FIG. 3 illustrates a side cross sectional view of the reactor cell 100 illustrated in FIG. 1 taken along line 3-3 in FIG. 2. The agitator assembly 104 comprises a rotatable shaft 106, a first impeller 108, and a second impeller 110. The shaft 106 is elongate and is rotatable about a vertical axis of rotation 10. The agitator assembly 104 is positionable within the vessel 102 to centrally suspend the shaft 106. When the agitator assembly 104 is positioned within the vessel, the vertical axis of rotation 10 aligns with a central axis 12 of the vessel 102. The central axis 12 of the vessel 102 extends through a center of the vessel 102 from a top 112 of the vessel 102 to a bottom 114 of the vessel 102. Any configuration of the impellers and shafts may be employed.

The first impeller 108 and the second impeller 110 are coupled to the rotatable shaft 106 in a spaced apart arrangement. The first impeller 108 is positioned toward a bottom of the shaft 106, and the second impeller 110 is positioned above the first impeller 108. In an aspect, the first impeller 108 is positioned at the bottom of the shaft 106. Both of the first and second impellers 108 and 110 may include multiple blades (e.g. hydrofoil blades). As illustrated, each of the first and second impellers 108 and 110 include four radially extending blades coupled to the shaft 106 so that rotation of the shaft 106 causes rotation of both the first and second impellers 108 and 110. It will be appreciated that fewer or more blades may be used for each impeller 108 and 110, for example, each impeller may have two blades, three blades, six blades, or another number of blades. In an aspect, each of the blades that compose each respective impeller 108 and 110 may be spaced equidistant apart from the other blades on their respective impeller 108 and 110 about the vertical axis of rotation 10. For example, an impeller with four blades includes each of the blades spaced apart by approximately 90°.

The vessel 102 is configured to contain a liquid within a chamber 122. The liquid may be a liquid mixture that comprises, for example, phosphate rock and sulfuric acid. The vessel 102 includes vessel walls 120 that extend from the bottom 114 to the top 112 of the vessel 102. Inner surfaces of the vessel walls 120 and the bottom 114 of the vessel 102 define the chamber 122. The chamber 122 may have a substantially rectangular shape. Alternatively, the chamber 122 may be substantially cylindrical, octagonal, or other configuration. The inner surfaces of the vessel walls 120 may be tapered, such that an inner perimeter of the inner surface at the top 112 of the vessel walls 120 is greater than an inner perimeter of the inner surface of the bottom 114 of the vessel walls 120. The vessel walls 120 may include an acid-resistant lining, such as acid brick.

The first impeller 108 is configured to pump liquid in a downward direction along the vertical axis of rotation 10 (e.g. a down-pumping impeller). For example, each blade is oriented such that as the first impeller 108 rotates within the liquid, the liquid surrounding the blades of the impeller 108 are impelled substantially axially in a downward direction. In an aspect, the first impeller 108 comprises a non-radial flow impeller. In this regard, creating the flow zones described herein preferably is performed by one or more axial impellers (that is, an impeller that is configured to produce axial flow) and/or mixed impellers (that is, an impeller that is configured to produce an element of axial flow and an element of radial flow). In an aspect, each of the first and second impellers 108 and 110 is configured to produce a flow that is primarily axial, but may also produce a secondary flow that is tangential (e.g. radial). The term “non-radial flow impeller” is intended to encompass axial impellers and mixed impellers, and to exclude impellers that are only configured to pump in a radial direction.

The second impeller 110 is configured to pump liquid in an upward direction along the vertical axis of rotation 10 (e.g. an up-pumping impeller). For example, each blade is oriented such that as the second impeller 110 rotates within the liquid, the liquid surrounding the blades of the impeller 110 are impelled substantially axially in an upward direction, which is a direction opposite to the downward direction that the first impeller 108 impels the liquid. In an aspect, the second impeller 110 comprises a non-radial flow impeller.

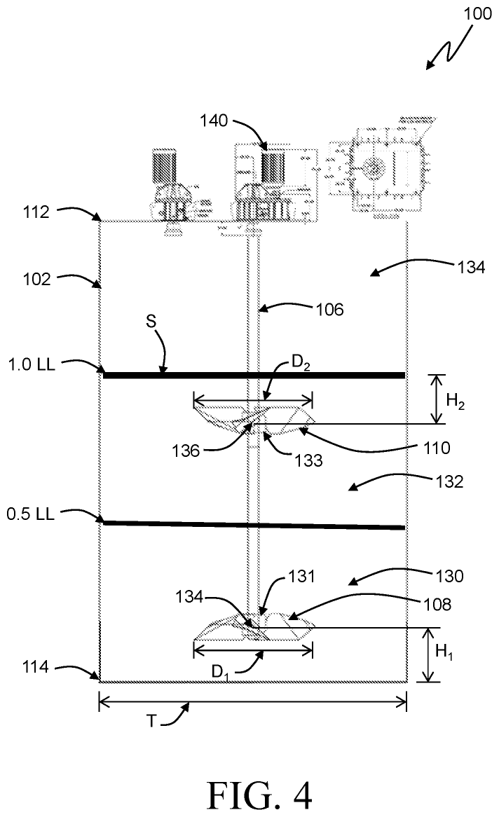

FIG. 4 illustrates a side view of an inside of the reactor cell 100, according to an aspect of this disclosure. The vessel 102 defines a first mixing zone 130 and a second mixing zone 132 located above the first mixing zone 130, each defined by a liquid level (“LL”). In this regard, the liquid level can be measured in operating tank or may be taken from the target operating level from the system operating manual.

When liquid is contained within the vessel 102, the first mixing zone 130 extends from the bottom 114 to a height of one-half the level of the liquid (labeled in FIG. 4 as 0.5 LL). The second mixing zone 132 extends from the liquid level 0.5 LL to the surface S of the liquid contained in the vessel 102 (labeled in FIG. 4 as 1.0 LL). The vessel 102 further defines a head zone 134 located above the first and the second mixing zones 130 and 132. In an aspect, each of the zones 130, 132, and 134 are preferably open, with no structure separating the zones (e.g. the interior surfaces of the vessel walls 120 may extend linearly from the bottom 114 to the top 112 of the vessel 102).

It will be appreciated that the first and second mixing zones 130 and 132 may include a different range of heights. For example, in a first alternative, the first mixing zone 130 may extend from the bottom 114 to a height of 0.3 LL and the second mixing zone 132 may extend from the liquid level 0.3 LL to the surface S. In a second alternative, the first mixing zone 130 may extend from the bottom 114 to a height of 0.4 LL and the second mixing zone 132 may extend from the liquid level 0.4 LL to the surface S. In a third alternative, the first mixing zone 130 may extend from the bottom 114 to a height of 0.6 LL and the second mixing zone 132 may extend from the liquid level 0.6 LL to the surface S. In a fourth alternative, the first mixing zone 130 may extend from the bottom 114 to a height of 0.7 LL and the second mixing zone 132 may extend from the liquid level 0.7 LL to the surface S. Preferably, the height of the first mixing zone 130 extending from the bottom 114 is at least 0.3 LL, and a height of the second mixing zone 132 extending from an upper most portion of the first mixing zone 130 to the surface S is at least 0.3 LL.

The first impeller 108 is coupled to the shaft 106 by a hub 131 at a first axial location 134 located within the first mixing zone 130. The first axial location 134 may correspond to a diameter D₁ of the first impeller 108. For example, the first axial location 134 may be located along the central axis 12 between the bottom 114 of the vessel 102 and a distance H₁ above the bottom of the vessel 102. The first axial location 134 may also be located at approximately the distance H₁ from the bottom 114 of the vessel 102. In an aspect, the distance H₁ extends upward from the bottom 114 and is approximately one-fourth the diameter D₁ of the first impeller 108 (e.g. H₁ equals approximately ¼ D₁). In an alternative aspect, a ratio between the distance H₁ and the first impeller diameter D₁ is between approximately 0.25 and 1.2. In a further aspect, the ratio between the distance H₁ and the first impeller diameter D₁ is between approximately 0.5 and 1.0.

The second impeller 110 is coupled to the shaft 106 by a hub 133 at a second axial location 136 located within the second mixing zone 132. The second axial location 136 may correspond to a diameter D₂ of the second impeller 110. For example, the second axial location 136 may be located along the central axis 12 between the surface S of the liquid within the vessel 102 and a distance H₂ below the surface S of the liquid. The second axial location 136 may also be located at approximately the distance H₂ from the surface S of the liquid within the vessel 102. In an aspect, the distance H₂ extends downward from the surface S and is approximately one-fourth the diameter D₂ of the second impeller 110 (e.g. H₂ equals approximately ¼ D₂). In an alternative aspect, a ratio between the distance H₂ and the second impeller diameter D₂ is between approximately 0.25 and 1.0. In a further aspect, the ratio between the distance H₂ and the second impeller diameter D₂ is between approximately one-third and two-thirds.

The diameters D1 and D2 of the first and second impellers 108 and 110 may correspond to a diameter T of the vessel 102 (e.g. cylindrical vessel). For example, the first impeller 108 may be sized such that a ratio between the diameter D₁ of the first impeller 108 and the diameter T of the vessel 102 is between approximately 0.25 and 0.60 (e.g. 0.25≤(D₁:T)≤0.60). Similarly, the second impeller 110 may be sized such that a ratio between the diameter D₂ of the second impeller 110 and the diameter T of the vessel 102 is between approximately 0.25 and 0.60 (e.g. 0.25≤(D₂:T)≤0.60). In an aspect, the diameter D₁ of the first impeller 108 is substantially the same as the diameter D₂ of the second impeller 110.

It will be appreciated that fewer or more impellers may be coupled to the shaft 106. For example, a third impeller (not shown) could be coupled to the shaft 106. The third impeller may be located between the first mixing zone 130 and the second mixing zone 132 (e.g. at the one-half level of the liquid (0.5 LL)), and the first and second impellers 108 and 110 would be positioned within the first and second mixing zones 130 and 132, respectively, as described above. In an aspect, the third impeller may be configured substantially similarly to the first impeller 108 to pump liquid in the downward direction along the vertical axis of rotation 10 (e.g. a down-pumping impeller). In another alternative aspect, a fourth impeller (not shown) could be coupled to the shaft 106. In this aspect, the third impeller may be located in the first mixing zone 130 and the fourth impeller may be located in the second mixing zone 132. The third impeller may be configured substantially similarly to the first impeller 108 to pump liquid in the downward direction, and the fourth impeller may be configured substantially similarly to the second impeller 110 to pump liquid in the upward direction along the vertical axis of rotation 10 (e.g. an up-pumping impeller). Each additional impeller coupled to the shaft 106 in the first mixing zone 130 may be configured to pump liquid in the downward direction along the vertical axis of rotation 10, and each additional impeller coupled to the shaft 106 in the 110 second mixing zone 32 may be configured to pump liquid in the upward direction along the vertical axis of rotation 10.

In an aspect, the blades of the first impeller 108 may be offset from the blades of the second impeller 110 about the vertical axis of rotation 10. For example, with reference to FIG. 2, the blades of the first impeller 108 are offset by approximately 45° from the blades of the second impeller 110 about the vertical axis of rotation 10. Similarly, for an impeller configuration having two blades on each impeller, the blades of each impeller may be offset by approximately 90°.

The agitator assembly 104 may also include a drive means 140 that drives the rotatable shaft 106 about the vertical axis of rotation 10. The drive means 140 may include an electric motor; however, alternative motors or means for driving the shaft 106 may be employed.

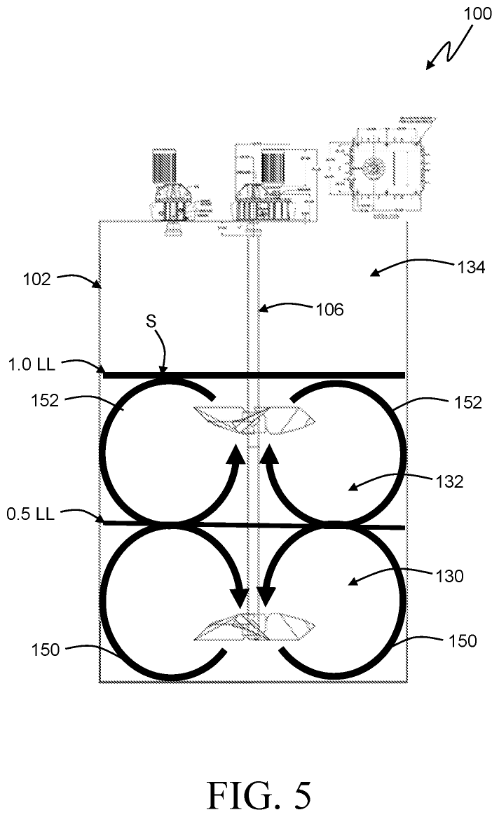

FIG. 5 illustrates a side view of an inside of the reactor cell 100 with indicator arrows schematically representing generalized liquid flow patterns produced by the impellers 108 and 110, according to an aspect of this disclosure. An example of a method for removing surface foam and entrained gasses from a liquid using the reactor cell 100 and agitator assembly 104 described herein includes a process of producing phosphoric acid. It will be appreciated that the reactor cell 100 and the agitator assembly 104 may be used in other applications, such as other three phase applications. The vessel 102 is filled with a liquid or liquid mixture (e.g. phosphate rock and sulfuric acid) to level LL. The liquid within the vessel 102 fills the first mixing zone 130 and the second mixing zone 132. In an aspect, the liquid is filled to a level such that a height of the head zone 134 is approximately one-third of a height of the vessel 102. The agitator assembly 104 is positioned within the vessel 102, such that the first impeller 108 is located within the first mixing zone 130 and the second impeller 110 is positioned within the second mixing zone 132. The agitator assembly 104 may be positioned within the vessel 102 before or after the vessel 102 is filled with the liquid. After the impellers 108 and 110 are positioned within their respective mixing zones 130 and 132, the rotatable shaft 106 is rotated by the drive means 140.

During rotation of the shaft 106, in the embodiment of the figures, the first (lower) impeller 108 pumps the liquid in the downward direction along the vertical axis of rotation 10. The downward pumping produces an inner downward flow and an outer upward flow along the inner surface of the vessel 102 in the first mixing zone 130. The zone 130 defined by flow produced by the downward pumping is illustrated in FIG. 5 by the arrows 150. The downward pumping produces a high velocity liquid flow that increases solids suspension and reduces mineral (e.g. gypsum-calcium sulfate) settling, build-up, and/or crystallization along the inner surfaces of the bottom 114 and sidewalls 120 of the vessel 102.

The second impeller 110, in the embodiment of the figures, pumps the liquid in the upward direction along the vertical axis of rotation 10 simultaneously with the first impeller 108 pumping the liquid in the downward direction. The upward pumping produces an inner upward flow and an outer downward flow to define the second mixing zone 132. The flow produced by the upward pumping is illustrated by arrows 152. The upward pumping produces a high surface velocity that increases degassing of reaction created gasses. The high velocity liquid flow in the second mixing zone 132 also reduces mineral build-up and/or crystallization on the sidewalls 120 of the vessel 102 compared to a radial flow foam breaker that splashes slurry against the sidewalls 120 in the head zone 134.

That inventors surmise that, in addition to liquid velocity near the walls in zones 130 and 132, the improvement in reducing build-up and degassing, is in part explained by liquid flows produced by the first impeller 108 and the second impeller 110 produce an impinging zone between the first mixing zone 130 and the second mixing zone 132. The impinging zone comprises a turbulent fluid flow whereby the fluid flowing upward along the outer wall in the first mixing zone 130 collides with the fluid flowing downward along the outer wall in the second mixing zone 132. After the fluid collides, the fluid flows radially toward the center of the vessel 102 (e.g. toward the shaft 106) and is either pumped downwardly by the first impeller 108 or pumped upwardly by the second impeller 110. The flow produced within the vessel 102 results in two flow patterns, one flow pattern in the first mixing zone 130 and another flow pattern in the second mixing zone 132. The two flow patterns reduce variation of retention time in each reactor cell.

In an aspect, and consistent with conventional parameters to promote impeller life, the shaft 106 is rotated at a speed such that both a tip of a blade of the first impeller 108 and a tip of a blade of the second impeller 110 have a tip velocity of less than 5 m/s. The tips of the blades of the first and second impellers 108 and 110 define the outermost tips of the blades of the first and second impellers 108 and 110, respectively. Agitator assemblies 104 are exposed to corrosive liquids and abrasive solids that degrade rotating equipment. The reduced impeller tip velocity reduces impeller wear which leads to lost performance, while still allowing the agitator assembly 104 to remove surface foam and entrained gasses and to prevent mineral build-up on the walls of the vessel 102. The removed entrained gasses is transferred to the head zone 134.

The fluid flow patterns formed by the agitator assembly 104 within the vessel 102 eliminates the need for using a defoaming agent to remove foam from the liquid mixture. However, a defoaming agent may still be used during reactor processing if desired. As used herein, the phase “without defoaming agent” includes introducing zero defoaming agent and employing a de minimis amount of defoaming agent. Even in circumstances in which a defoaming agent may be used, the inventors believe that employing the structure and function of the present disclosure should significantly diminish the amount of defoaming agent required.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Further, the information (including but not limited to the background discussion) is not intended to limit the scope of the invention to addressing a particular problem or providing a particular solution. Thus, the discussion should not be taken to indicate that any particular element of a prior system is unsuitable for use with the innovations described herein, nor is it intended to indicate that any element is essential in implementing the innovations described herein.

1. A reactor for removal of entrained gas from a liquid, the reactor comprising:
a vessel for containing the solid-liquid-gas or liquid-gas mixture, the vessel defining a first mixing zone and a second mixed mixing zone located above the first mixed mixing zone; and
an agitator assembly positionable within the vessel, the agitator assembly comprising:
a rotatable shaft configured to rotate about a vertical axis of rotation,
a first impeller coupled to the rotatable shaft at a first axial location, the first axial location being locatable within the first mixing zone, the first impeller being configured to pump the liquid in a downward direction along the vertical axis of rotation, and
a second impeller coupled to the rotatable shaft at a second axial location, the second axial location being locatable within the second mixing zone, the second impeller being configured to pump the liquid in an upward direction along the vertical axis of rotation.

2. The reactor of claim 1, wherein the agitator assembly is configured to produce (a) an inner downward flow and an outer upward flow in the first mixing zone, and (b) an inner upward flow and an outer downward flow in the second mixing zone.

3. The reactor of claim 2, wherein the agitator assembly is further configured to produce an impinging mixing zone between the first mixing zone and the second mixing zone.

4. The reactor of claim 1, wherein when liquid is contained within the vessel, the first mixing zone extends in an axial direction from a bottom of the vessel to a location that is half a height of the liquid contained in the vessel, and the second mixing zone extends in the axial direction from the location that is half the height of the liquid to the surface of the liquid contained in the vessel.

5. The reactor of claim 4, wherein the first impeller has a first impeller diameter, and wherein the first axial location is located a first distance from the bottom of the vessel in the axial direction, wherein a ratio between the first distance and the first impeller diameter is between approximately 0.25 and 1.2.

6. The reactor of claim 4, wherein the second impeller has a second impeller diameter, and wherein the second axial location is located a distance from the surface of the vessel toward the bottom of the vessel by a second height, wherein a ratio between the second height and the second impeller diameter is between approximately 0.25 and 1.0.

7. The reactor of claim 4, wherein the vessel further defines a head zone, wherein the head zone extends from the surface of the liquid to a top of the vessel.

8. The reactor of claim 1, wherein the first impeller has a first impeller diameter, the second impeller has a second impeller diameter, and the vessel has a vessel diameter, wherein a ratio between the first impeller diameter and the vessel diameter is between approximately 0.25 to 0.60, and wherein a ratio between the second impeller diameter and the vessel diameter is between approximately 0.25 to 0.60.

9. The reactor of claim 1, wherein the first impeller and the second impeller comprise non-radial flow impellers.

10. The reactor of claim 1, wherein the vessel is one of a plurality of vessels, the plurality of vessels comprising 8 vessels, and wherein the agitator assembly is one of a plurality of agitator assemblies, the plurality of agitator assemblies comprising 8 assemblies such that each assembly is positioned within a respective vessel.

11. (canceled)

12. A method for removing entrained gas, the method comprising:
filling a vessel with a liquid mixture, the vessel defining a first mixing zone and a second mixing zone, the liquid mixture filling the first and second mixing zones;
positioning an agitator assembly within the vessel, the agitator assembly including a rotatable shaft configured to rotate about a vertical axis of rotation, a first impeller coupled to the rotatable shaft and configured to pump the liquid mixture in a downward direction along the vertical axis of rotation, and a second impeller coupled to the rotatable shaft configured to pump the liquid mixture in an upward direction along the vertical axis of rotation, the positioning step comprising:
positioning the first impeller within the first mixing zone, and
positioning the second impeller within the second mixing zone; and
rotating the rotatable shaft about the vertical axis of rotation causing the first impeller to pump the liquid mixture in the downward direction and causing the second impeller to pump the liquid mixture in the upward direction.

13. The method of claim 12, wherein the rotating step comprises rotating the first impeller and the second impeller such that tip speeds of the first and second impellers are less than 5 m/s.

14. The method of claim 12, wherein rotating the rotatable shaft of the agitator assembly produces (a) an inner downward flow and an outer upward flow in the first mixing zone, and (b) an inner upward flow and an outer downward flow in the second mixing zone.

15. The method of claim 14, wherein rotating the rotatable shaft of the agitator assembly produces an impinging mixing zone between the first mixing zone and the second mixing zone.

16. The method of claim 12, wherein the first mixing zone extends in an axial direction from a bottom of the vessel to a location that is half a height of the liquid mixture contained in the vessel, and the second mixing zone extends in the axial direction from the location that is half the height of the liquid mixture to the surface of the liquid contained in the vessel.

17. The reactor of claim 16, wherein the first impeller has a first impeller diameter, and wherein the first impeller is positioned a distance from the bottom of the vessel in the axial direction that is substantially equal to one-fourth of the liquid height.

18. The reactor of claim 16, wherein the second impeller has a second impeller diameter, and wherein the second impeller is positioned a distance from the surface of the vessel toward the bottom of the vessel that is substantially equal to one-fourth of the liquid height.

19. The reactor of claim 16, wherein the vessel further defines a head zone, wherein the head zone extends from the surface of the liquid to a top of the vessel, wherein the entrained gas removed from the liquid is contained in the head zone.

20. The method of claim 12, wherein the liquid mixture comprises phosphate rock and sulfuric acid.

21. The method of claim 12, wherein the first impeller has a first impeller diameter, the second impeller has a second impeller diameter, and the vessel has a vessel diameter, wherein a ratio between the first impeller diameter and the vessel diameter is between approximately 0.25 to 0.60, and wherein a ratio between the second impeller diameter and the vessel diameter is between approximately 0.25 to 0.60.

22. An agitator assembly for use in a vessel of a reactor to remove entrained gas, the vessel being configured to contain a liquid within a first mixing zone and a second mixing zone located above the first mixing zone, the agitator assembly comprising:
a rotatable shaft configured to rotate about a vertical axis of rotation;
a first impeller coupled to the rotatable shaft at a first axial location, the first axial location being locatable within the first mixing zone, the first impeller being configured to pump the liquid in a downward direction along the vertical axis of rotation; and
a second impeller coupled to the rotatable shaft at a second axial location, the second axial location being locatable within the second mixing zone, the second impeller being configured to pump the liquid in an upward direction along the vertical axis of rotation,
wherein the agitator assembly is configured to produce (a) an inner downward flow and an outer upward flow in the first mixing zone and (b) an inner upward flow and an outer downward flow in the second mixing zone when the rotatable shaft is rotated and the first impeller is positioned within the first mixing zone and the second impeller is positioned within the second mixing zone.

23. A method of manufacturing a reactor cell for removing entrained gas from a liquid, the reactor cell including a vessel configured to contain a liquid within a first mixing zone and a second mixing zone located above the first mixing zone, the method comprising:
coupling a first impeller to a rotatable shaft at a first axial location, the first axial location being locatable within the first mixing zone, the first impeller being configured to pump the liquid in a downward direction; and
coupling a second impeller to the rotatable shaft at a second axial location, the second axial location being locatable within the second mixing zone, the second impeller being configured to pump the liquid in an upward direction,
wherein the rotatable shaft is configured to rotate about a vertical axis of rotation, and wherein the first impeller and the second impeller are configured to produce (a) an inner downward flow and an outer upward flow in the first mixing zone and (b) an inner upward flow and an outer downward flow in the second mixing zone when the rotatable shaft is rotated and the first impeller is positioned within the first mixing zone and the second impeller is positioned within the second mixing zone.

24. The method of claim 23, further comprising:
positioning the first impeller within the first mixing zone; and
positioning the second impeller within the second mixing zone.
